(19) United States
(12) Patent Application Publication
(10) Pub. No.: US 2026/0048621 A1
(43) Pub. Date: Feb. 19, 2026

(54) METHOD FOR DETERMINING PRESSURE LOSS IN TIRE OF FOUR-WHEELED VEHICLE

(71) Applicant: Deere & Company, Moline, IL (US)

(72) Inventors: ONKAR KANICHE, PUNE (IN); SOURABHA S. GOKHALE, PUNE (IN); FLORIAN SCHOTT, Einhausen (DE)

(21) Appl. No.: 19/302,259

(22) Filed: Aug. 18, 2025

(30) Foreign Application Priority Data
Aug. 19, 2024 (EP) 24195124.3

(51) Int. Cl. B60C 23/06

(52) U.S. Cl. CPC B60C 23/061; B60C 23/067

(57) ABSTRACT

A first and second acceleration measuring devices are mounted on a rigid vehicle structure spaced apart from each other in the longitudinal and transverse direction of the vehicle. A first or second inclination variable is determined by the acceleration measuring devices and characterizes a longitudinal or transverse inclination of the vehicle structure relative to a predetermined horizontal plane in a first or second reference point assigned to the respective acceleration measuring device. Components of the first or second inclination variable during the journey of the vehicle are eliminated by an evaluation unit on the basis of a coincidence resulting from the travel speed of the vehicle and a direction-of-travel-related distance between the two reference points, to conclude, based on a remaining invariant component of the first or second inclination variable, that there is a loss of pressure in one of the tires.

### CROSS-REFERENCE TO RELATED APPLICATIONS

This application claims priority to European Patent Application No. 24195124.3, filed Aug. 19, 2024, which is hereby incorporated by reference.

### TECHNICAL FIELD

The present disclosure relates generally to a method for determining a pressure loss in a tire of a four-wheeled vehicle.

### BACKGROUND

In the automotive sector, methods for determining a pressure loss occurring in a tire are usually based on a direct measurement of the tire internal pressure, for which purpose each of the vehicle wheels is assigned an individual pressure and temperature sensor. The pressure and temperature information recorded in this way is transmitted telemetrically to a control unit located in the vehicle, which, when an inadmissible tire pressure is detected, causes the output of a corresponding driver's note via a user interface. The pressure and temperature sensor, which is combined in a sensor unit with a radio transponder, is usually located on the inside of a rim or tire in the region of a tire valve and is mounted together therewith. Since each of the vehicle wheels has its own sensor unit, the construction of such tire pressure monitoring systems is not only relatively complex, but each of the sensor units also requires its own power supply in the form of a built-in battery. The life expectancy of the battery is in the order of a few years. If it needs to be replaced, the tire must first be removed from the rim in order to be able to access the relevant sensor unit.

In addition, methods for indirect measurement of the tire's internal pressure are known. These are based, for example, on a complex analysis of the rolling or vibration behavior of the tire casing.

### SUMMARY

It is the object of the present disclosure to specify a method of the type mentioned above, which allows the detection of an undesirable tire pressure loss on a four-wheeled vehicle with comparatively little effort.

This object is achieved by a method for determining a pressure loss in a tire of a four-wheeled vehicle, said method having the features of one or more embodiments disclosed herein.

In the method for determining a pressure loss in a tire of a four-wheeled vehicle, it is provided that first and second acceleration measuring devices are mounted on a rigid vehicle structure spaced apart from each other in the longitudinal and transverse direction of the vehicle, wherein a first or second inclination variable is determined by means of the acceleration measuring devices and characterizes a longitudinal and/or transverse inclination of the vehicle structure relative to a predetermined horizontal plane in a first or second reference point assigned to the respective acceleration measuring device, wherein components of the first or second inclination variable during the journey of the vehicle, which are due to substrate-induced changes in the longitudinal and/or transverse inclination, are eliminated by an evaluation unit on the basis of a coincidence resulting from the travel speed of the vehicle and a direction-of-travel-related distance between the two reference points, to conclude, based on a remaining invariant component of the first or second inclination, that there is a loss of pressure in one of the tires.

The method takes advantage of the fact that a four-wheeled vehicle tilts diagonally in the direction of the tire concerned in the event of a loss of pressure on one of the tires. This diagonal inclination remains largely unchanged while the vehicle is moving and results in the occurrence of a corresponding offset of the first or second inclination variable. If such an offset remains after filtering out the substrate-induced components, it can be reliably concluded that there is too little tire internal pressure in one of the tires. This allows at least a qualitative assessment of the tire's internal pressure, which is completely sufficient for most applications (for example, to issue a tire pressure warning).

To what extent the first or second inclination variable determined is proportional to a substrate-induced change in the longitudinal and/or transverse inclination can be determined on the basis of the characteristic circumstance that the change in both acceleration measuring devices occurs in succession in a time interval corresponding to the travel speed of the vehicle and the direction-of-travel-related distance of the two reference points. The time course of the inclination variables determined by the two acceleration measuring devices then substantially corresponds to a phase shift corresponding to the time interval. If the difference between the two courses is formed taking this phase shift into account, only a temporally invariant component of the first or second inclination variable, if any, remains.

The acceleration measuring devices are available in large quantities at a comparatively low cost. In addition, these are already present in some control units to evaluate the driving dynamics with regard to the vehicle's pitch, roll and yaw movements that occur as a result of driving, so that co-use is an easy option. Nevertheless, retrofitting without significant technical effort is also possible. The inclination information provided by the acceleration measuring devices can be transmitted to the evaluation unit for further processing via a CAN data bus.

Advantageous embodiments of the method according to the disclosure can be found in one or more embodiments disclosed herein.

Preferably, the determination of the pressure loss by the evaluation unit is carried out under the condition of a previously detected change in the longitudinal and/or transverse inclination of the vehicle structure. Thus, it is first checked whether a change in inclination occurs at all on the vehicle structure. If this is not the case, a further evaluation of the determined inclination variables does not lead to any usable result and can be omitted from the outset. An inefficient application of the (microprocessor-controlled) evaluation unit with the execution of unnecessary computing operations can thus be avoided.

It is also possible that, starting from the evaluation unit, based on the determined invariant component of the first or second inclination variable and a diagonal inclination of the vehicle structure resulting in the direction of the affected tire, not only is it concluded that there is an undesirable tire pressure loss, but also that the tire affected by the pressure loss is positioned on the vehicle.

In this context, it is conceivable that, at the request of the evaluation unit, in the event of a detected pressure loss, information indicating the pressure loss and the position of the affected tire is output via a data interface.

The output of the information can be carried out as a tire pressure warning via a vehicle display and/or by wireless transmission to a central data server, to which, for example, a maintenance service has access, which can provide a suitable spare tire in the context of a mobile service operation. Such a remote diagnosis is especially useful for fully autonomous vehicles, as there is no operator on site who could provide the relevant information.

Other features and aspects will become apparent by consideration of the detailed description, claims, and accompanying drawings.

### BRIEF DESCRIPTION OF THE DRAWINGS

The method according to the disclosure will be explained in more detail hereinafter on the basis of the appended drawings. Component parts of equivalent or comparable function are identified by the same reference signs in this case.

FIG. 1 shows an exemplary embodiment, illustrated as a block diagram, of the method according to the disclosure for determining a pressure loss in a tire of a four-wheeled vehicle.

FIG. 2 shows a schematically illustrated exemplary embodiment of a tire pressure monitoring system provided in an agricultural tractor in which the procedural function is realized.

FIG. 3 shows an exemplary driving situation of the agricultural tractor when driving on uneven or hilly terrain.

FIG. 4 shows an inclination profile detected by means of a first acceleration measuring device when driving on the terrain shown in FIG. 3.

FIG. 5 shows an inclination profile detected by means of a second acceleration measuring device when driving on the terrain shown in FIG. 3.

Like reference numerals are used to indicate like elements throughout the several figures.

### DETAILED DESCRIPTION

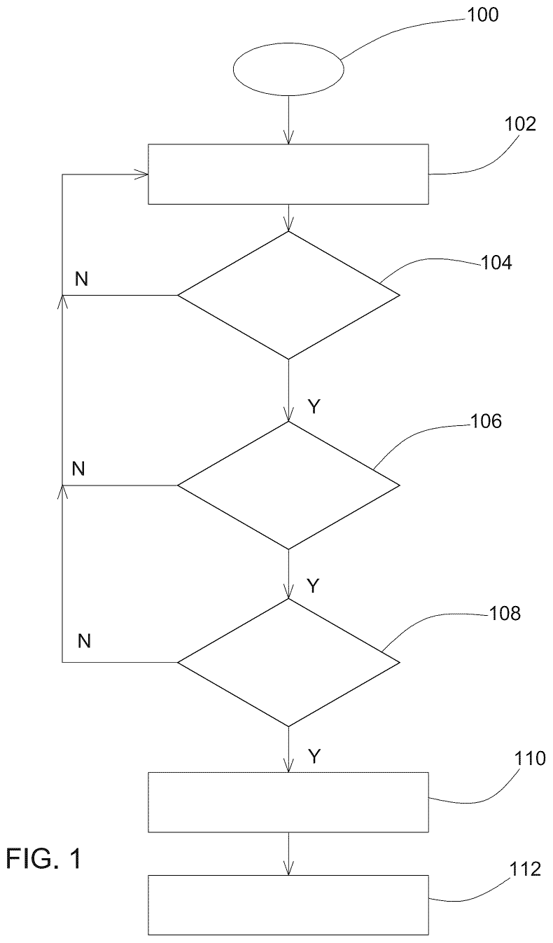

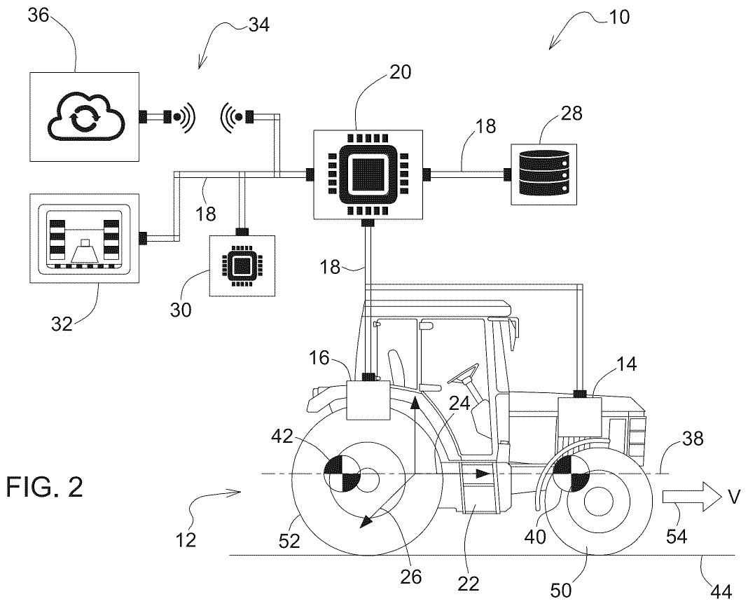

FIG. 1 shows an exemplary embodiment of the method according to the disclosure for determining a pressure loss in a tire of a four-wheeled vehicle, the function of which is realized in the tire pressure monitoring system shown in FIG. 2.

For a better understanding, the structure of the tire pressure monitoring system 10 will be discussed first. The tire pressure monitoring system 10 housed in an agricultural tractor 12 comprises first and second acceleration measuring devices 14, 16 for providing inclination information, which is transmitted via a CAN data bus 18 to a microprocessor-controlled evaluation unit 20 for further processing. As is indicated in FIG. 2, the two acceleration measuring devices 14, 16 are mounted, spaced apart from one another, on a rigid vehicle structure 22 of the agricultural tractor 12 in the longitudinal and transverse direction of the vehicle 24, 26. Furthermore, the evaluation unit 20 communicates via the CAN data bus 18 with a storage unit 28 and a data interface 30, which serves to activate a vehicle display 32 and to establish a wireless data transmission connection 34 with an external data server 36.

According to FIG. 1, the method carried out by the evaluation unit 20 and stored in the storage unit 28 as a corresponding program code is started in a first step 100 with commissioning of the agricultural tractor 12, whereupon, in a second step 102, a first or second inclination variable is determined by the evaluation unit 20 on the basis of the inclination information provided via the CAN data bus 18 and characterizes the longitudinal and/or transverse inclination of the vehicle structure 22 relative to a predetermined horizontal plane 38 in a first or second reference point 40, 42 assigned to the respective acceleration measuring devices 14, 16. A longitudinal inclination of the vehicle structure 22 is understood in the present case to mean a rotation about a rotation axis coinciding with the vehicle transverse direction 26, and a transverse inclination is understood to mean a rotation about a rotation axis coinciding with the vehicle longitudinal direction 26.

The assignment of the two reference points 40, 42 to the acceleration measuring devices 14, 16 is carried out in such a way that they lie in the predetermined horizontal plane 38 when the agricultural tractor 12 is stood on a flat substrate 44 (see FIG. 2).

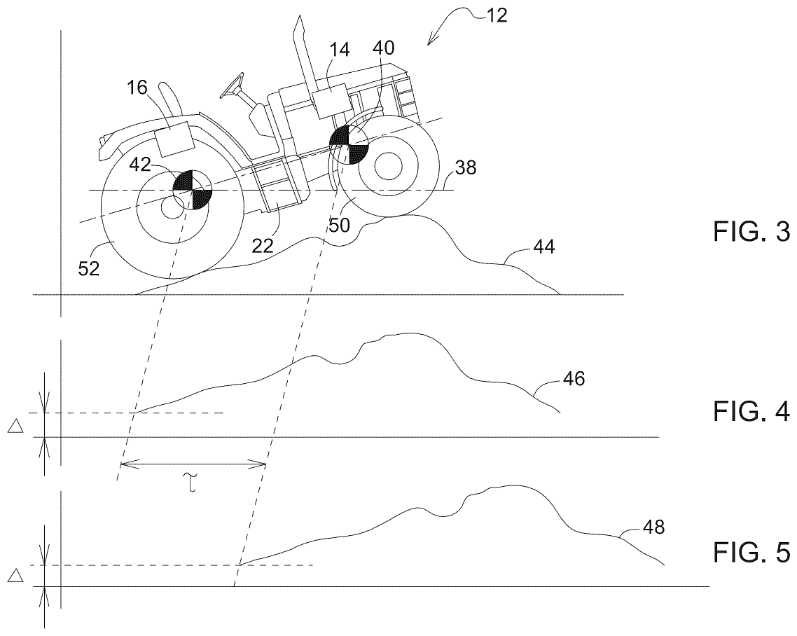

The determined first or second inclination value is then checked in a third step 104 with regard to a change in the longitudinal and/or transverse inclination of the vehicle structure 22 occurring relative to the substrate 44. If such a change can be derived from at least one of the two inclination variables, as in the case of the driving situation of the agricultural tractor 12 shown in FIG. 3 as an example when driving on uneven or hilly terrain, then a fourth step 106 is continued. Otherwise, the method returns again to the second step 102. In other words, the continuation of the method with the fourth step 106 is subject to a change in the longitudinal and/or transverse inclination of the vehicle structure 22 as previously detected in the third step 104.

By means of each of the two acceleration measuring devices 14, 16, an inclination profile 46, 48 characterizing the course of the driven substrate 44 is ultimately detected. This is shown by way of example in FIGS. 4 and 5.

In the fourth step 106, the evaluation unit 20 identifies and then eliminates components of the first or second inclination variable during the driving of the agricultural tractor 12 which are due to substrate-induced changes in the longitudinal and/or transverse inclination. The latter is based on a coincidence resulting from the driving speed v of the agricultural tractor 12 and a travel-direction-related distance of the two reference points 40, 42. If the evaluation unit 20 determines in a fifth step 108 a remaining invariant component of the first or second inclination variable, it concludes in a sixth step 110 the presence of a pressure loss in one of the tires 50, 52 of the agricultural tractor 12. Only the right tires 50, 52 can be seen; the left tires are hidden in the selected view. The driving speed v of the agricultural tractor 12 is determined here by the evaluation unit 20 from wheel speed information that is present on the CAN data bus 18.

Optionally, it is provided in the sixth step 110 that, starting from the evaluation unit 20, based on the determined invariant component of the first or second inclination variable and a diagonal inclination of the vehicle structure 22 resulting in the direction of the affected tire 50, not only is it concluded that there is an undesirable tire pressure loss, but also that the tire 50 affected by the pressure loss is positioned on the agricultural tractor 12. As an example, this is the right front tire 50 of the agricultural tractor 12.

If such components of the first or second inclination variable in the fourth step 106 or fifth step 108 cannot be derived, the method returns to the second step 102 in each case.

Generally speaking, the method makes use of the recognition that the four-wheeled agricultural tractor 12 (like any four-wheeled vehicle equipped with pneumatic tires) tilts diagonally in the direction of the tire 50, 52 in the event of a pressure loss occurring on one of the tires 50, 52. This diagonal inclination resulting from the superposition of a longitudinal and transverse inclination of the vehicle structure 22 remains largely unchanged during the travel of the agricultural tractor 12 and leads to the occurrence of a corresponding offset Δ of the first or second inclination variable. If such an offset Δ remains after filtering out the substrate-induced components, it can be reliably concluded that there is too little tire internal pressure in one of the tires 50, 52.

To what extent the first or second inclination variable determined is proportional to a substrate-induced change in the longitudinal and/or transverse inclination is determined by the evaluation unit 20 on the basis of the characteristic circumstance that the change in both acceleration measuring devices 14, 16 occurs in succession in a time interval τ corresponding to the driving speed v of the agricultural tractor 12 and the direction-of-travel-related distance of the two reference points 40, 42. The time course of the inclination variables determined by the two acceleration measuring devices 14, 16 then substantially corresponds to a phase shift corresponding to the time interval τ. If the difference between the two courses is formed taking this phase shift into account, only a temporally invariant component, in the form of a corresponding offset Δ, of the first or second inclination variable, if any, remains.

This behavior is illustrated in FIG. 3 in conjunction with FIGS. 4 and 5. If the agricultural tractor 12 moves on uneven or hilly terrain, a change in inclination in the direction of travel 54 is initially detected by the first acceleration measuring device 14 (see FIG. 4) and only then is the time interval τ resulting from the driving speed v of the agricultural tractor 12 and the travel-direction-related distance of the two reference points 40, 42 detected by the second acceleration measuring device 16 (see FIG. 5). In this way, a permanent inclination due to a loss of tire pressure can be reliably distinguished from substrate-induced changes in inclination occurring during driving.

In a seventh step 112 it is further provided that, at the request of the evaluation unit 20 in the event of a pressure loss detected in the sixth step 110, information indicating the pressure loss and the position of the affected tire 50 is output via the data interface 30. The output of the information is carried out as a tire pressure warning via the vehicle display 32 and/or by wireless transmission to the central data server 36, to which, for example, a maintenance service has access, which can provide a suitable spare tire in the context of a mobile service operation.

For the sake of completeness, it should be noted that the vehicle does not necessarily have to be an agricultural tractor 12; rather, the method according to the disclosure can also be used for four-wheeled vehicles of any other type.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for determining a pressure loss in a tire of a four-wheeled vehicle, comprising:
determining a first or second inclination variable by a first or second acceleration measuring device, wherein the first and second acceleration measuring device are mounted on a rigid vehicle structure spaced apart from each other in the longitudinal and transverse direction of the vehicle,
characterizing a longitudinal or transverse inclination of the vehicle structure relative to a predetermined horizontal plane in a first or second reference point assigned to the respective acceleration measuring device by the first or second inclination variable,
eliminating components of the first or second inclination variables during the journey of the vehicle, which are due to substrate-induced changes in the longitudinal or transverse inclination, by an evaluation unit on the basis of a coincidence resulting from the travel speed of the vehicle and a direction-of-travel-related distance between the first and second reference points, to conclude, based on a remaining invariant component of the first or second inclination variable, that there is a loss of pressure in one of the tires.

2. The method of claim 1, wherein the determination of the pressure loss is carried out by the evaluation unit under the condition of a previously recognized change in the longitudinal or transverse inclination of the vehicle structure.

3. The method of claim 1, wherein, starting from the evaluation unit, based on the determined invariant component of the first or second inclination variable and the diagonal inclination of the vehicle structure resulting in the direction of the affected tire, it is concluded that the tire affected by the pressure loss is positioned on the vehicle.

4. The method of claim 3, wherein, at the request of the evaluation unit, in the event of a detected pressure loss, information indicating the pressure loss and the position of the affected tire is output via a data interface.

5. The method of claim 4, wherein the information is output as a tire pressure warning via a vehicle display or by wireless transmission to a central data server.

6. A four-wheeled vehicle, comprising:
a rigid vehicle structure,
tires,
a first and second acceleration measuring devices mounted on the rigid vehicle structure spaced apart from each other in the longitudinal and transverse direction of the vehicle, the first or second acceleration measuring devices configured to determine a first or second inclination variable, which characterizes a longitudinal or transverse inclination of the vehicle structure relative to a predetermined horizontal plane in a first or second reference point assigned to the respective acceleration measuring device, and
an evaluation unit configured to eliminate components of the first or second inclination variables during the journey of the vehicle, which are due to substrate-induced changes in the longitudinal or transverse inclination, on the basis of a coincidence resulting from the travel speed of the vehicle and a direction-of-travel-related distance between the first and second reference points, to conclude, based on a remaining invariant component of the first or second inclination variable, that there is a loss of pressure in one of the tires.

7. The method of claim 1, wherein the determination of the pressure loss is carried out by the evaluation unit under the condition of a previously recognized change in the longitudinal or transverse inclination of the vehicle structure.

8. The method of claim 1, wherein, starting from the evaluation unit, based on the determined invariant component of the first or second inclination variable and the diagonal inclination of the vehicle structure resulting in the direction of the affected tire, it is concluded that the tire affected by the pressure loss is positioned on the vehicle.

9. The method of claim 8, wherein, at the request of the evaluation unit, in the event of a detected pressure loss, information indicating the pressure loss and the position of the affected tire is output via a data interface.

10. The method of claim 9, wherein the information is output as a tire pressure warning via a vehicle display or by wireless transmission to a central data server.
